(19) United States
(12) Patent Application Publication
(10) Pub. No.: US 2016/0228906 A1
(43) Pub. Date: Aug. 11, 2016

(54) ROUND TYPE FERRITE APPLICATOR FOR DIPOLE LIGHTNING ROD

(71) Applicant: Young-ki CHUNG, Seoul (KR)

(72) Inventor: Young-ki CHUNG, Seoul (KR)

(21) Appl. No.: 14/663,154

(22) Filed: Mar. 19, 2015

(30) Foreign Application Priority Data
Feb. 6, 2015 (KR) 10-2015-0018684

(51) Int. Cl. B05C 13/00; B05C 1/06

(52) U.S. Cl. CPC B05C 13/00; B05C 1/06

(57) ABSTRACT

Disclosed herein is a round type ferrite applicator for a dipole lightning rod. The ferrite applicator may include a compression air generation unit configured to generate and charge compressed air, a flat plate type base plate extended in a specific length, a piston assembly installed in the base plate and configured to perform a straight-line reciprocating motion, a control unit configured to transfer the compressed air from the compression air generation unit to the piston assembly and to control an electric operation, a movable plate connected to the piston assembly and configured to support the bottom of the electrification tube and to have an accommodation groove for accommodating a ferrite coating pad formed in the movable plate, and an elastic pressurization means placed over the movable plate and configured to elastically pressurize the top of the electrification tube and simultaneously guide the electrification tube so that the electrification tube rotates. Accordingly, a task for attaching the ferrite coating pad for reducing a corona pre-discharge current and a corona preliminary discharge voltage can be automated and uniformly performed with respect to the electrification tube, and the reliability and productivity of a task can be significantly improved.

### CROSS REFERENCE TO RELATED APPLICATION

The present application claims the benefit of Korean Patent Application No. 10-2015-0018684 filed in the Korean Intellectual Property Office on Feb. 6, 2015, the entire contents of which are incorporated herein by reference.

### BACKGROUND OF THE INVENTION

1. Technical Field

The present invention relates to a round type ferrite applicator for a dipole lightning rod and, more particularly, to a round type ferrite applicator for a dipole lightning rod, wherein a ferrite coating layer for increasing a corona pre-discharge current and lowering a corona discharge starting voltage with respect to a specific element forming the dipole lightning rod is formed.

2. Description of the Related Art

In general, a lightning protection device is installed at the top of a building in order to safely discharge charges, accumulated on a thundercloud, to the earth by forming a discharge path between the thundercloud and the earth.

A conventional dipole lightning protection device is described below with reference to FIG. 1.

As illustrated in FIG. 1, the conventional dipole lightning protection device includes a fixing unit 31 installed at the top of a building and connected to earth means, a rod 30 configured to have one end fixed to the fixing unit 31 electrically charged by the charges of the earth, a rod cap 32 coupled with the other end of the rod 30 and configured to guide the falling of a thunderbolt, an insulator 34 and metallic electrification plates 37 and 38 coupled with one side of the rod 30 in the length direction thereof, and electrification means 45 disposed under the electrification plates 37 and 38. The rod 30 is embedded at the center of an electrification tube 45a.

The electrification means 45 includes the electrification tube 45a configured to have a tubular shape, have the rod 30 penetrate the center of the electrification tube 45a, and have a needle-shaped tip 45b formed on the part of the rod 30 and a first cap 45c and a second cap 45d configured to couple both ends of the electrification tube 45a with the rod 30. The second cap 45d is closely fixed to the insulator 34 by a stopper 46.

A dipole lightning protection device, such as that illustrated in FIG. 1, is disclosed in Korean Patent No. 0856719 that was invented by Jung Yong-ki who is the same inventor as that of the present invention.

However, the conventional dipole lightning protection device configured as described above is problematic in that a preliminary discharge corona discharge start voltage is irregularly generated between the electrification plates 37 and 38 (also called “discharge-assistant members”) electrically charges when a thundercloud approaches and the rod 30 connected to charges accumulated on the electrification tube 45a and the earth.

In particular, it was found that the conventional dipole lightning protection device is limited in increasing a preliminary discharge current after the preliminary discharge start.

Accordingly, the inventor has developed a plurality of technologies related to the dipole lightning protection device and had some patent rights regarding the dipole lightning protection device. In a process of developing various structures for rapidly discharging charges accumulated on a thundercloud to the earth after a preliminary discharge is started in a lightning protection device using a dipole, the inventor has published that the effect of “a magnetic field on the start voltage and current of a corona discharge is based on a cyclone motion according to a Lorentz force” through a collection of papers called “The effect of the magnetic fields on the corona discharge” in the Korean Institute of Illuminating and Electrical Installation Engineers Thesis Vol. 15 No. 3 (published on May 2001, a writer Jae-yun Park including 2 persons). Furthermore, the inventor has discovered that a magnetic field affects a corona discharge through “Analysis of the electromagnetic phenomena in vacuum interrupter with axial magnetic field type, Journal of the Korean Institute of Electrical and Electronic Material Engineers Vol. 16. 2003. 10. 10” to which a technology for extinguishing an arc generated between electrodes from which a corona discharge is generated when magnetic fields are applied between the electrodes has been applied. Furthermore, the inventor discovered that a magnetic field is generated when the falling of a thunderbolt is introduced into a flat plate through “Certification of aircraft system and avionics equipment against lightning indirect effect” (Aerospace Engineering and Technology Vol. 4 No. 1, Sang-ho Han).

Furthermore, the inventor has discovered that a phenomenon is generated in which assuming that the size of an electrical dipole according to an electric dual layer between electrification electrodes having a dielectric interposed therebetween is “d” and a dipole moment is P(t)=q(t)d, a current considers a dipole having a current of I=\dot{q}=p/d to be as a pair of dot charges and thus flows from one dot charge to the other dot charge.

Under the aforementioned theoretical backgrounds, the inventor has discovered that in such a magnetic field and dielectric, an electric dipole generated by the electric dual layer is one of factors that affect the corona preliminary discharge generated in the dipole lightning rod when a thundercloud approaches. In order to increase the corona pre-discharge current and lower the corona discharge voltage in the dipole lightning protection devices invented by and issued to the inventor, the inventor has developed and manufactured a coating layer or film made of magnetic material powder having a dielectric property and binder resin, such as epoxy. Accordingly, the inventor has discovered through several hundreds of experiments that if the coating layer is coated on the electrostatic induction body (e.g., the electrification plate or the electrification tube or both) of the dipole lightning protection device or a film layer is formed using the coating layer, the corona pre-discharge current and the corona preliminary discharge voltage are reduced. Accordingly, there is a need for an apparatus capable of uniformly automating a coating task for the electrostatic induction body.

### PRIOR ART DOCUMENT

### Patent Document

Korean Patent No. 0856719 (Aug. 29, 2008)

### SUMMARY OF THE INVENTION

Accordingly, the present invention has been made keeping in mind the above problems occurring in the prior art, and an object of the present invention is to provide a round type ferrite applicator for a dipole lightning rod, wherein a ferrite coating layer for increasing a corona pre-discharge current and lowering a corona discharge starting voltage with respect to a specific element forming the dipole lightning rod is formed.

In an embodiment, a round type ferrite applicator for a dipole lightning rod may include a compression air generation unit configured to generate and charge compressed air, a flat plate type base plate extended in a specific length, a piston assembly installed in the base plate and configured to perform a straight-line reciprocating motion, a control unit configured to transfer the compressed air from the compression air generation unit to the piston assembly and to control an electric operation, a movable plate connected to the piston assembly and configured to support the bottom of a electrification tube and to have an accommodation groove for accommodating a ferrite coating pad formed in the movable plate, and an elastic pressurization means placed over the movable plate and configured to elastically pressurize the top of the electrification tube and simultaneously guide the electrification tube so that the electrification tube rotates.

A guide rail extended in a specific length may be formed in the base plate, and rail coupling units coupled with the guide rail may be formed in the movable plate.

A pair of the guide rails may be respectively installed on one side and the other side that are adjacent to each other.

The piston assembly may include a piston body installed on one side of the base plate in the length direction of the base plate and a piston rod coupled with the piston body and configured to perform a straight-line reciprocating motion. A detection sensor may be installed between the piston body and the movable plate and configured to detect timing at which the direction of the piston rod is changed after the detection sensor comes in contact with the movable plate moving in a straight line.

The elastic pressurization means may include a pressurization plate installed over the movable plate, support legs equipped with coupling means supporting the pressurization plate so that a height of the pressurization plate is controllable, elastic springs installed in the respective support legs and configured to enable the pressurization plate to elastically move up and down, and a separation prevention member installed at the back of the pressurization plate and configured to prevent the electrification tube from being laterally separated by interfering with one side and the other side of the electrification tube in the length direction of the electrification tube.

When viewed based on the pressurization plate, the coupling means may include a plurality of first coupling nuts installed below the pressurization plate and configured to set the height of the pressurization plate and a plurality of second coupling nuts installed above the pressurization plate and configured to control elastic pressure of the elastic springs.

Leg units for height adjustment may be formed in the base plate. The leg units for height adjustment may maintain a tilt angle so that the side in which the movable plate is placed is higher than the side in which the control unit is placed when the base plate is laterally viewed.

The round type ferrite applicator may further include a shelf frame configured to support the base plate at a location spaced apart from a ground at a specific height.

### BRIEF DESCRIPTION OF THE DRAWINGS

FIG. 1 is a perspective view illustrating the configuration of a conventional dipole lightning protection device;

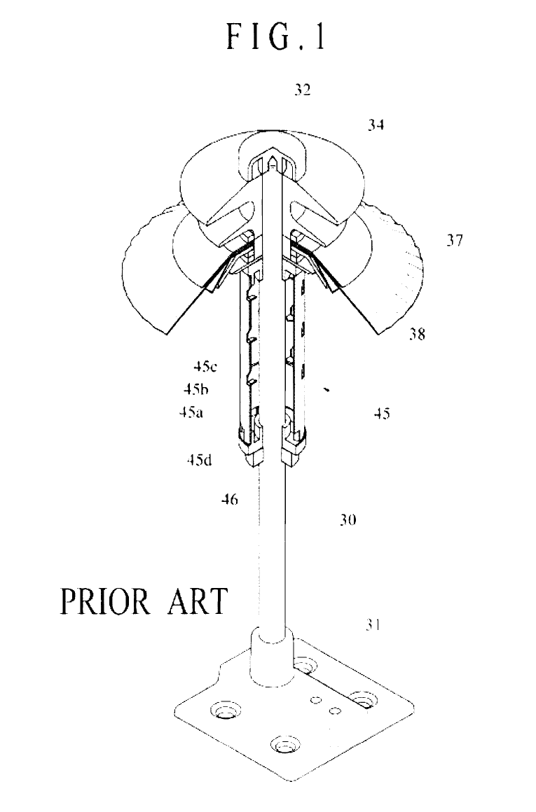

FIG. 2 is a perspective view of a round type ferrite applicator for a dipole lightning rod according to an embodiment of the present invention;

FIG. 3 is an enlarged perspective view of FIG. 2 which is viewed at a different angle;

FIG. 4 is a side view of FIG. 3;

FIG. 5 is a partial enlarged view illustrating the operation of the round type ferrite applicator for a dipole lightning rod according to an embodiment of the present invention; and

FIG. 6 is a perspective view illustrating a process of coupling another auxiliary electrification tube with the electrification tube of FIG. 5 in the state in which a ferrite coating pad is wound on the electrification tube.

<Description of reference numerals>

| | |
|---|---|
| 100: compression air generation unit | |
| 200: base plate | 300: piston assembly |
| 330: detection sensor | 400: control unit |
| 500: movable plate | |
| 600: elastic pressurization means | |
| 610: pressurization plate | 620: coupling means |
| 630: support leg | 640: elastic spring |
| 650: separation prevention member | |
| 10: electrification tube | P: ferrite coating pad |

### DETAILED DESCRIPTION

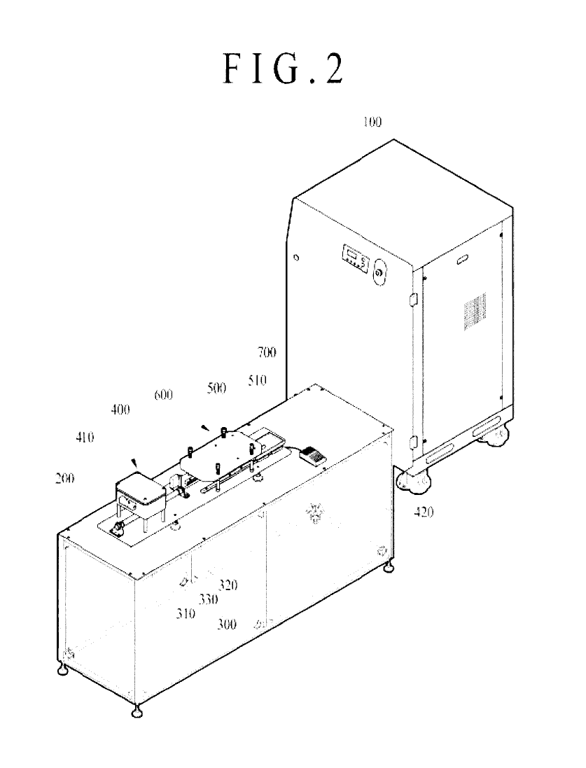

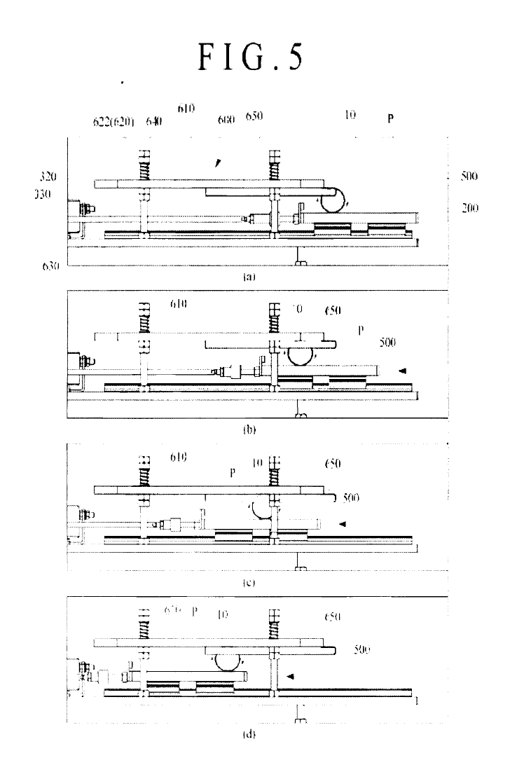

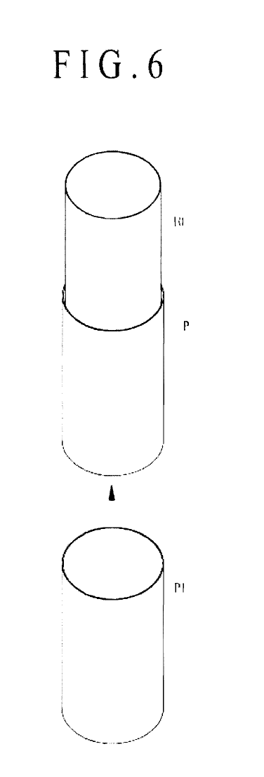

Hereinafter, embodiments of the present invention are described in detail with reference to FIGS. 2 to 6.

Prior to a description, it is to be noted that a ferrite coating material used in the present invention is fabricated in a square pad shape having a specific area and adhesives for adhesion have been coated on one surface of a ferrite coating pad P.

Furthermore, in the present invention, a term “coating” should be construed as including all of terms “cladding”, “stacking”, and “adhesion.”

As illustrated in FIGS. 2 to 6, the round type ferrite applicator for a dipole lightning rod according to an embodiment of the present invention is an apparatus for coating a ferrite coating material on the outer circumference surface of an electrification tube 10 that forms the dipole lightning rod. The round type ferrite applicator may be configured to include a compression air generation unit 100 configured to generate and charge compressed air, a flat plate type base plate 200 extended in a specific length, a piston assembly 300 installed in the base plate 200 and configured to perform a straight-line reciprocating motion, a control unit 400 configured to transfer the compressed air from the compression air generation unit 100 to the piston assembly 300 and to control an electric operation, a movable plate 500 connected to the piston assembly 300 and configured to support the bottom of the electrification tube 10 and to have an accommodation groove 510 for accommodating a ferrite coating pad P therein formed in the movable plate 500, and an elastic pressurization means 600 placed over the movable plate 500 and configured to elastically pressurize the top of the electrification tube 10 and simultaneously guide the electrification tube 10 so that the electrification tube 10 rotates.

First, the compression air generation unit 100 generates compressed air using an externally electrified current. The generated compressed air is used to drive an apparatus using a force of pressure.

The compression air generation unit 100 may be configured to have a box-shaped cabinet structure having a specific size. The cabinet may include a compressor (not illustrated) for compressing air, an air storage unit (not illustrated) for storing the compressed air, and a pressure check valve (not illustrated) for checking a change of pressure within the air storage unit in real time.

The base plate 200 is formed of a metallic sheet extended in a specific width and length.

A guide rail 210 for guiding the sliding movement of the movable plate 500 is formed in a top surface of the base plate 200 according to an embodiment of the present invention. A pair of the guide rails 210 may be configured to be respectively installed on one side and the other side of the base plate 200 in the length direction thereof, but the present invention is not necessarily limited thereto. For example, only a single guide rail 210 may be formed at the center of the base plate 200 in the length direction thereof.

Furthermore, leg units 220 for height adjustment are formed in the base plate 200.

Each of the leg units 220 for height adjustment may include a vertical member 221 coupled with the base plate 200 and a support 222 screwed onto the end of the vertical member 221.

Furthermore, the support 222 may be made of a synthetic resin material having a high friction coefficient, such as rubber or silicon.

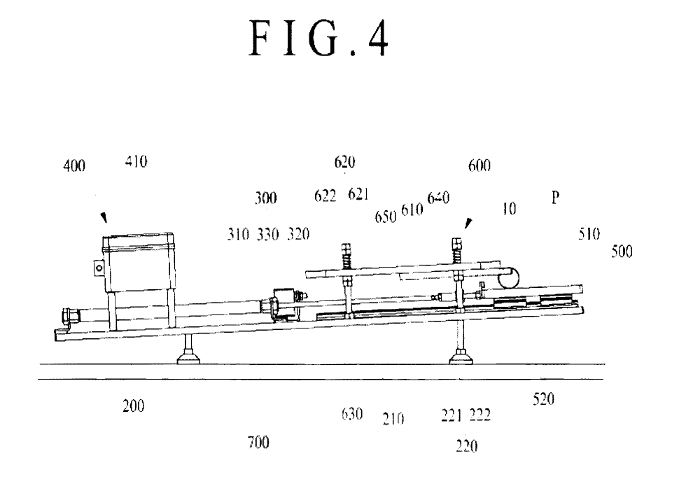

Furthermore, when the base plate 200 is laterally viewed, it may maintain an inclined structure in which one side of the base plate 200 is higher than the other side thereof in the length direction of the base plate 200 (refer to FIG. 4).

More specifically, the base plate 200 may maintain a tilt angle so that the side in which the movable plate 500 is placed is higher than the side in which the control unit 400 to be installed in the base plate 200 is placed. The reason for this is that the ferrite coating pad P can be more smoothly attached by the rotation movement of the electrification tube 10.

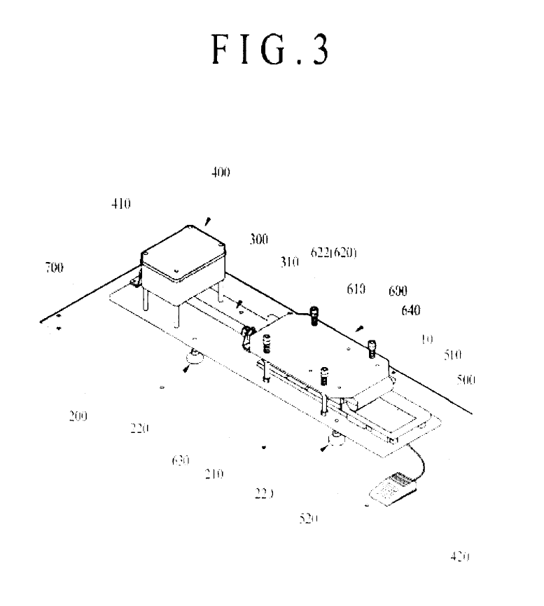

As illustrated in FIGS. 2 and 3, the round type ferrite applicator for a dipole lightning rod according to an embodiment of the present invention may be configured to further include a shelf frame 700 for supporting the base plate 200 at the location spaced apart from the ground at a specific height.

The piston assembly 300 is installed in the base plate 200. The piston assembly 300 may include a piston body 310 installed on one side of the base plate 200 in the length direction thereof and a piston rod 320 coupled with the piston body 310 and configured to perform a straight-line reciprocating motion.

That is, the piston rod 320 of the piston assembly 300 performs a straight-line reciprocating motion in response to air pressure supplied by the compression air generation unit 100.

Furthermore, a detection sensor 330 is installed between the piston body 310 and the movable plate 500 and configured to detect timing at which the direction of the piston rod 320 is changed after the detection sensor 330 comes in contact with the movable plate 500 moving in a straight line.

More specifically, when the detection sensor 330 comes in contact with the movable plate 500 connected to the piston rod 320 in a process of the piston rod 320 moving toward the piston body 310, the piston rod 320 no longer moves toward the piston body 310 and changes its direction in order to move in a straight line in an opposite direction.

In this case, the detection sensor 330 may be formed of a limit switch installed at a location close to the piston body 310.

The control unit 400 is installed on one side of the base plate 200 in the length direction thereof, and functions to transfer the compressed air from the compression air generation unit 100 to the piston assembly 300 and to control the operations of various electric devices.

The control unit 400 may include a control main body 410 configured to have an installation space part formed therein, a control plate (not illustrated) mounted on the installation space part, and an operation switch 420 electrically connected to the control plate.

A method of performing pressure transfer and electric control using the control unit 400 is the same as or similar to that of a known control apparatus, and a detailed construction and operation thereof are omitted.

The movable plate 500 is connected to the piston assembly 300 and configured to move in a straight line back and forth in the direction in which the piston rod 320 moves.

The movable plate 500 may be a flat plate type sheet having a specific width. A space part for supporting the electrification tube 10 is provided on one side of a surface of the movable plate 500. The accommodation groove 510 for accommodating the ferrite coating pad P is formed on the other side of the movable plate 500.

More specifically, when the piston rod 320 performs a straight-line motion toward the piston main body 310 in the state in which the electrification tube 10 has been disposed on one side of the movable plate 500 and the ferrite coating pad P has been accommodated in the accommodation groove 510 on the other side of the movable plate 500, the elastic pressurization means 600 disposed over the movable plate 500 transfers applied pressure that softly presses the top of the electrification tube 10. In this case, the electrification tube 10 to which the pressed pressure is transferred relatively rotates with respect to the direction in which the movable plate 500 moves and moves toward the ferrite coating pad P. Accordingly, in the process of the electrification tube 10 rotating and moving, the ferrite coating pad P is naturally closely attached to the outer circumference of the electrification tube 10.

Thereafter, after the ferrite coating pad P is wound on the electrification tube 10, when the movable plate 500 comes in contact with the detection sensor 330, the control unit 400 controls the movable plate 500 so that it backward moves in a straight line in response to the operation signal of the detection sensor 330. At this time, the electrification tube 10 relatively rotates in an opposite direction and returns to its original location.

When the adhesion of the ferrite coating pad P to the outer circumference of the electrification tube 10 is completed as described above, the auxiliary electrification tube 11 having a greater diameter than the electrification tube 10 is additionally coupled with the ferrite coating pad P, thus surrounding and protecting the ferrite coating pad P so that it is not externally exposed.

Furthermore, rail coupling units 520 coupled in accordance with the guide rail 210 are formed on the other surface of the movable plate 500.

The guide rail 210 and the rail coupling units 520 enable the movable plate 500 to perform a sliding action more easily.

The elastic pressurization means 600 is placed over the movable plate 500, and functions to elastically pressurize and simultaneously guide the top of the electrification tube 10 so that the electrification tube 10 rotates.

More specifically, the elastic pressurization means 600 may include a pressurization plate 610 installed over the movable plate 500, support legs 630 equipped with coupling means 620 supporting the pressurization plate 500 so that the height of the pressurization plate 500 is controllable, elastic springs 640 installed in the respective support legs 630 and configured to enable the pressurization plate 500 to elastically move up and down, and a separation prevention member 650 installed at the back of the pressurization plate 610 and configured to prevent the electrification tube 10 from being laterally separated by interfering with one side and the other side of the electrification tube 10 in the length direction of the electrification tube 10.

The elastic pressurization means 600 may transfer applied pressure that presses the electrification tube 10 from top to bottom so that the electrification tube 10 moving along the movable plate 500 is relatively rotated.

The coupling means 620 functions to control its height in accordance with the diameter of the electrification tube 10 or control elastic pressure with respect to the direction in which the pressurization plate 500 moves up and down.

In this case, when viewed based on the pressurization plate 500, the coupling means 620 may include a plurality of first coupling nuts 621 installed below the pressurization plate 500 and configured to set the height of the pressurization plate 500 and a plurality of second coupling nuts 622 installed above the pressurization plate 500 and configured to control elastic pressure of the elastic springs 640.

As described above, in accordance with the present invention, the round type ferrite applicator includes the piston assembly 300, the movable plate 500, and the elastic pressurization means 600. Accordingly, there are advantages in that a task for attaching the ferrite coating pad P for reducing a corona pre-discharge current and a corona preliminary discharge voltage can be automated and uniformly performed with respect to the electrification tube, and the reliability and productivity of a task can be significantly improved.

What is claimed is:

1. A round type ferrite applicator for a dipole lightning rod, the ferrite applicator comprising:
a compression air generation unit configured to generate and charge compressed air;
a flat plate type base plate extended in a specific length;
a piston assembly installed in the base plate and configured to perform a straight-line reciprocating motion;
a control unit configured to transfer the compressed air from the compression air generation unit to the piston assembly and to control an electric operation;
a movable plate connected to the piston assembly and configured to support a bottom of a electrification tube and to have an accommodation groove for accommodating a ferrite coating pad formed in the movable plate; and
an elastic pressurization means placed over the movable plate and configured to elastically pressurize a top of the electrification tube and simultaneously guide the electrification tube so that the electrification tube rotates.

2. The round type ferrite applicator of claim 1, wherein:
a guide rail extended in a specific length is formed in the base plate, and
rail coupling units coupled with the guide rail is formed in the movable plate.

3. The round type ferrite applicator of claim 2, wherein a pair of the guide rails is respectively installed on first and second sides that are adjacent to each other.

4. The round type ferrite applicator of claim 2, wherein:
the piston assembly comprises a piston body installed on one side of the base plate in a length direction of the base plate and a piston rod coupled with the piston body and configured to perform a straight-line reciprocating motion, and
a detection sensor is installed between the piston body and the movable plate and configured to detect timing at which a direction of the piston rod is changed after the detection sensor comes in contact with the movable plate moving in a straight line.

5. The round type ferrite applicator of claim 2, wherein the elastic pressurization means comprises:
a pressurization plate installed over the movable plate,
support legs equipped with coupling means supporting the pressurization plate so that a height of the pressurization plate is controllable,
elastic springs installed in the respective support legs and configured to enable the pressurization plate to elastically move up and down, and
a separation prevention member installed at a back of the pressurization plate and configured to prevent the electrification tube from being laterally separated by interfering with first and second sides of the electrification tube in a length direction of the electrification tube.

6. The round type ferrite applicator of claim 5, wherein when viewed based on the pressurization plate, the coupling means comprises a plurality of first coupling nuts installed below the pressurization plate and configured to set a height of the pressurization plate and a plurality of second coupling nuts installed above the pressurization plate and configured to control elastic pressure of the elastic springs.

7. The round type ferrite applicator of claims 1, wherein:
leg units for height adjustment are formed in the base plate, and
the leg units for height adjustment maintain a tilt angle so that a side in which the movable plate is placed is higher than a side in which the control unit is placed when the base plate is laterally viewed.

8. The round type ferrite applicator of claims 1, further comprising a shelf frame configured to support the base plate at a location spaced apart from a ground at a specific height.
